(19) United States
(12) Patent Application Publication
(10) Pub. No.: US 2015/0212618 A1
(43) Pub. Date: Jul. 30, 2015

(54) GESTURE INPUT DEVICE

(71) Applicant: Primax Electronics Ltd, Taipei (TW)

(72) Inventor: SHIH-CHIEH LAN, Taipei (TW)

(73) Assignee: Primax Electronics Ltd, Taipei (TW)

(21) Appl. No.: 14/286,662

(22) Filed: May 23, 2014

(30) Foreign Application Priority Data
Jan. 28, 2014 (CN) 201410042275.1

(51) Int. Cl. G06F 3/044; G06F 3/0488

(52) U.S. Cl. CPC G06F 3/044; G06F 3/0488

(57) ABSTRACT

A gesture input device includes an operating plate, a first infrared light sensing unit, a second infrared light sensing unit, and a controlling unit. Each of the first infrared light sensing unit and the second infrared light sensing unit includes an infrared light source and an image sensor. A first portion of the infrared light beam within a specified wavelength range is absorbed by the plural blood vessels of the finger, and a second portion of the infrared light beam beyond the specified wavelength range is reflected from the plural blood vessels. According to plural infrared images generated by the first infrared light sensing unit and the second infrared light sensing unit, the controlling unit generates a displacement information corresponding to the movement of the finger in order to control the computer.

### FIELD OF THE INVENTION

The present invention relates to a gesture input device, and more particularly to a gesture input device with infrared light sensing units.

### BACKGROUND OF THE INVENTION

Nowadays, a variety of electronic devices are designed in views of convenience and humanization. Consequently, a gesture input device is provided to cooperate with the electronic device and control the electronic device. The gesture input device may recognize various actions of the user's hand (especially the actions of the user's finger) and generate different gesture signals according to different actions of the finger. According to the gesture signals, various functions of the electronic device are correspondingly controlled.

For example, a capacitive touch device may recognize a position of a user's finger according to a change of a capacitance that is generated between the user's finger and an electric field, and acquire the action of the user's finger according to the position of the user's finger. For example, the action of the user's finger includes a clicking action, a sliding action or a rotating action. Moreover, according to the action of the user's finger, a corresponding gesture signal is generated and transmitted to the electronic device that needs to be controlled. Alternatively, a recognition object may be held by the user's hand or the recognition object may be worn on the user's finger. After the image of the user is captured by an image capture device, the position of the recognition object may be realized. Then, the action of the user's hand or the user's finger is analyzed according to the change of the position of the recognition object. Consequently, the corresponding gesture signal is generated.

However, for judging the action of the user's finger at a high speed and in a high precision, the conventional gesture input device should be specially designed. In other words, the fabricating cost of the gesture input device is very high. Consequently, this gesture input device cannot be successfully applied to the par electronic device.

Therefore, there is a need of providing an improved gesture input device in order to overcome the above drawbacks.

### SUMMARY OF THE INVENTION

The present invention relates to a gesture input device with low fabricating cost.

In accordance with an aspect of the present invention, there is provided a gesture input device for inputting a gesture signal into a computer. The gesture input device includes an operating plate, a first infrared light sensing unit, a second infrared light sensing unit, and a controlling unit. The first infrared light sensing unit and the second infrared light sensing unit are disposed on the operating plate, and detect a movement of a finger of a user. The first infrared light sensing unit and the second infrared light sensing unit are arranged in a row. Each of the first infrared light sensing unit and the second infrared light sensing unit includes an infrared light source and an image sensor. The infrared light source emits an infrared light beam that is absorbable by plural blood vessels of the finger. When the infrared light beam from the infrared light source is projected on the finger, a first portion of the infrared light beam within a specified wavelength range is absorbed by the plural blood vessels of the finger, and a second portion of the infrared light beam beyond the specified wavelength range is reflected from the plural blood vessels. After the second portion of the infrared light beam reflected from the finger is received by the image sensor, plural infrared images are generated. The controlling unit is electrically connected with the first infrared light sensing unit and the second infrared light sensing unit. When the finger is moved from a position over the first infrared light sensing unit to a position over the second infrared light sensing unit, the plural infrared images are generated by the first infrared light sensing unit and the second infrared light sensing unit. According to the plural infrared images, the controlling unit generates a displacement information corresponding to the movement of the finger in order to control the computer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a gesture input device and a computer according to a first embodiment of the present invention;

FIG. 2 is a schematic functional block diagram illustrating the gesture input device according to the first embodiment of the present invention;

FIG. 3 schematically illustrates the first infrared light sensing unit used in the gesture input device according to the embodiment of the present invention;

FIG. 4 schematically illustrates the connection between a gesture input device and a computer according to a second embodiment of the present invention;

FIG. 5 is a schematic functional block diagram illustrating the gesture input device according to the second embodiment of the present invention;

FIG. 6 schematically illustrates the connection between a gesture input device and a computer according to a third embodiment of the present invention;

FIG. 7 is a schematic functional block diagram illustrating the gesture input device according to the third embodiment of the present invention;

FIG. 8 schematically illustrates the relation between the user's finger and the gesture input device according to the third embodiment of the present invention;

FIG. 9 schematically illustrates the cursor movement controlled by the gesture input device according to the third embodiment of the present invention;

FIG. 10 schematically illustrates the connection between a gesture input device and a computer according to a fourth embodiment of the present invention; and

FIG. 11 is a schematic functional block diagram illustrating the gesture input device according to the fourth embodiment of the present invention.

### DETAILED DESCRIPTION OF THE PREFERRED EMBODIMENT

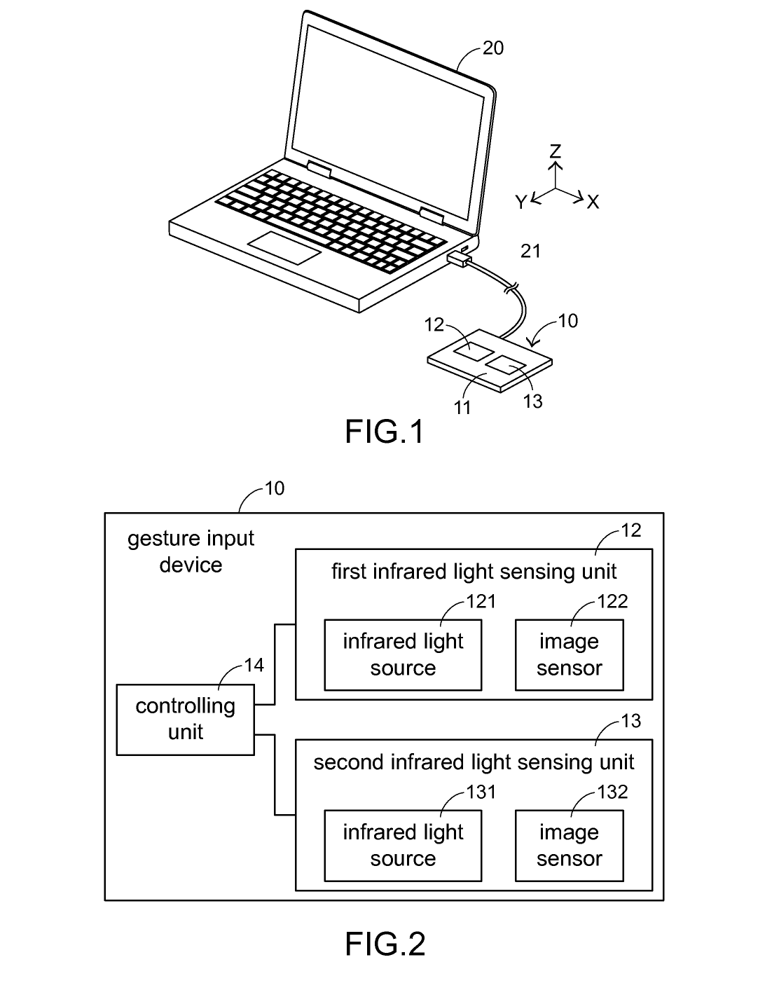

FIG. 1 schematically illustrates the connection between a gesture input device and a computer according to a first embodiment of the present invention. As known in FIG. 1, the gesture input device 10 is in communication with the computer 20 in a well-known connecting manner. Via the gesture input device 10, a gesture signal is inputted into the computer 20 in order to control the computer 20. The gesture input device 10 may be in communication with the computer 20 by a wired transmission technology or a wireless transmission technology. By the wired transmission technology, the gesture input device 10 may be in communication with the computer 20 through a USB connecting wire, a Micro USB connecting wire or any other well-known connecting wire. The wireless transmission technology includes a radio frequency communication technology, an infrared communication technology, a Bluetooth communication technology or an IEEE 802.11 communication technology. In this embodiment, the gesture input device 10 is a touchpad or a touch screen, and the computer 20 is a notebook computer. Moreover, the gesture input device 10 is in communication with the computer 20 through a USB connecting wire 21, but is not limited thereto.

Please also refer to FIG. 2. FIG. 2 is a schematic functional block diagram illustrating the gesture input device according to the first embodiment of the present invention. As shown in FIGS. 1 and 2, the gesture input device 10 comprises an operating plate 11, a first infrared light sensing unit 12, a second infrared light sensing unit 13, and a controlling unit 14. The operating plate 11 is a flat plate. A user's hand (especially a user's palm) may be placed on the operating plate 11. Consequently, while the gesture input device 10 is operated by the user, the hand fatigue may be alleviated. It is noted that the operating plate 11 is not restricted to the flat plate. In some other embodiments, the operating plate 11 is an inclined plate, an externally-convex curvy plate or an internally-concaved curvy plate in order to meet ergonomic demands or meet the requirements of different users.

The first infrared light sensing unit 12 and the second infrared light sensing unit 13 are disposed on a top surface of the operating plate 11 for detecting a movement of a user's finger over the operating plate 11. In this embodiment, the first infrared light sensing unit 12 and the second infrared light sensing unit 13 are arranged in a row. In addition, the first infrared light sensing unit 12 and the second infrared light sensing unit 13 are arranged side by side on the operating plate 11. As shown in FIG. 1, the first infrared light sensing unit 12 is located at a left side of the top surface of the operating plate 11, and the second infrared light sensing unit 13 is located at a right side of the top surface of the operating plate 11.

The first infrared light sensing unit 12 comprises an infrared light source 121 and an image sensor 122. The second infrared light sensing unit 13 comprises an infrared light source 131 and an image sensor 132. The controlling unit 14 is disposed within the operating plate 11, and electrically connected with the first infrared light sensing unit 12 and the second infrared light sensing unit 13. The signals from the first infrared light sensing unit 12 and the second infrared light sensing unit 13 may be received by the controlling unit 14. According to the signals from the first infrared light sensing unit 12 and the second infrared light sensing unit 13, the controlling unit 14 generates a corresponding gesture signal. After the gesture signal is generated by the controlling unit 14, the gesture signal is transmitted from the controlling unit 14 to the computer 20 through the USB connecting wire 21. According to the gesture signal, the computer 20 is correspondingly controlled.

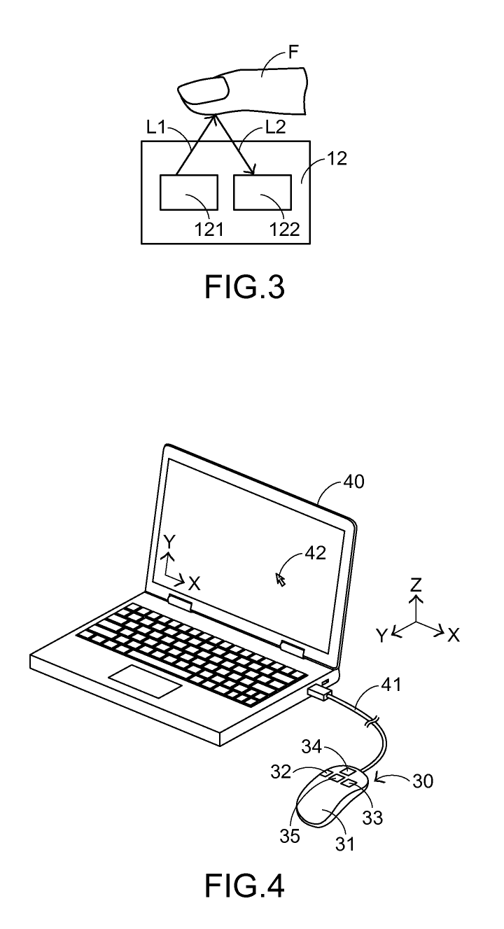

The process of using the infrared light sensing units to detect the user's finger will be illustrated as follows. Please refer to FIG. 3. FIG. 3 schematically illustrates the first infrared light sensing unit used in the gesture input device according to the embodiment of the present invention. As shown in FIG. 3, the infrared light source 121 and the image sensor 122 are disposed within the first infrared light sensing unit 12. In an embodiment, the infrared light source 121 is a well-known infrared light emitting diode. The infrared light source 121 may emit an infrared light beam L1 to the user's finger F. The infrared light beam L1 has a wavelength in the range between 700 nanometers and 10 millimeters. An example of the image sensor 122 is a well-known charge coupled device (CCD). The image sensor 122 may receive a reflected infrared light beam L2 from the user's finger F and generate an infrared image according to the reflected infrared light beam L2.

In particular, the blood of the blood vessel of the human body contains hemoglobin, and the portion of the infrared light beam within a specified wavelength range (e.g. between 700 nanometers and 1000 nanometers) may be absorbed by hemoglobin. Consequently, when the infrared light beam L1 with the wavelength in the range between 700 nanometers and 10 millimeters is projected on the user's finger F, the portion of the infrared light beam within the wavelength range between 700 nanometers and 1000 nanometers is absorbed by plural blood vessels of the user's finger F. On the other hand, the infrared light beam L2 beyond the wavelength range between 700 nanometers and 1000 nanometers cannot be absorbed by the plural blood vessels of the user's finger F. Consequently, the infrared light beam L2 is reflected to the image sensor 122, and then received by the image sensor 122.

After the infrared light beam L2 reflected from the user's finger F is received by the image sensor 122, the image sensor 122 generates n infrared images per seconds. Next, the plural infrared images are sequentially transmitted from the image sensor 122 to the controlling unit 14. The larger n value indicates that the image sensor 122 generates more infrared images per seconds. Under this circumstance, the sensitivity of the first infrared light sensing unit 12 is enhanced. Since the operating principle of the second infrared light sensing unit 13 is similar to that of the first infrared light sensing unit 12, the process of using the second infrared light sensing unit 13 to detect the user's finger is not redundantly described herein.

After the plural infrared images from the first infrared light sensing unit 12 and the second infrared light sensing unit 13 are received by the controlling unit 14, the plural infrared images are analyzed by the controlling unit 14 according to the well-known image recognition method. Consequently, the controlling unit 14 judges the occurring time point and the occurring sequence of the user's finger F in order to acquire a displacement information associated with the movement of the user's finger F.

For example, the user's finger F (see FIG. 3) may be moved from the position over the first infrared light sensing unit 12 to the position over the second infrared light sensing unit 13 while the user's finger F is contacted with the operating plate 11 or not contacted with the operating plate 11. Consequently, a gesture indicating the movement along an X-axis direction is generated. Under this circumstance, the image of the user's finger F is firstly contained in the plural infrared images that are generated by the first infrared light sensing unit 12, and then contained in the plural infrared images that are generated by the second infrared light sensing unit 13.

After the plural infrared images from the first infrared light sensing unit 12 and the second infrared light sensing unit 13 are received by the controlling unit 14, the plural infrared images are analyzed by the controlling unit 14. Consequently, a displacement information indicating the movement of the user's finger F from left to right is realized by the controlling unit 14. According to the displacement information, the controlling unit 14 generates a corresponding gesture signal to the computer 20 in order to control the computer 20. The method of analyzing the plural infrared images is similar to the conventional image analyzing method, and is not redundantly described herein.

On the other hand, if the user's finger F is moved from the position over the second infrared light sensing unit 13 to the position over the first infrared light sensing unit 12, plural infrared images from the first infrared light sensing unit 12 and the second infrared light sensing unit 13 are received by the controlling unit 14. According to the plural infrared images, the displacement information indicating the movement of the user's finger F is moved from right to left is realized by the controlling unit 14. According to the displacement information, the controlling unit 14 generates a corresponding gesture signal to the computer 20.

The control function corresponding to the above-mentioned gesture signals may be defined by the controlling unit 14 of the gesture input device 10 or defined by a specified application program of the computer 20. The control function may be the well-known control functions of controlling the computer 20. An example of the control function includes but is not limited to a function of controlling a sound volume, a function of controlling the direction of flipping a page, or a function of controlling the direction of scrolling a window. For example, if the displacement information indicates that the user's finger F is moved from left to right, the sound volume of the computer 20 is increased according to the gesture signal, the image shown on a display screen of the computer 20 is flipped from left to right or the window shown on the display screen of the computer 20 is scrolled from left to right. On the other hand, if the displacement information indicates that the user's finger F is moved from right to left, the sound volume of the computer 20 is decreased according to the gesture signal, the image shown on a display screen of the computer 20 is flipped from right to left or the window shown on the display screen of the computer 20 is scrolled from right to left. In a preferred embodiment, the sound volume of the computer 20 is controlled according to the gesture signal.

Hereinafter, a second embodiment of the present invention will be illustrated with reference to FIG. 4. FIG. 4 schematically illustrates the connection between a gesture input device and a computer according to a second embodiment of the present invention. As known in FIG. 4, the gesture input device 30 is in communication with the computer 40 through a USB connecting wire 41. Via the gesture input device 30, a gesture signal is inputted into the computer 40 in order to control the computer 40. In this embodiment, the gesture input device 30 is a touch mouse. Except for the number and arrangement of the infrared light sensing units, the configurations and operating principles of the gesture input device 30 of the second embodiment are substantially identical to those of the gesture input device 10 of FIGS. 1-3.

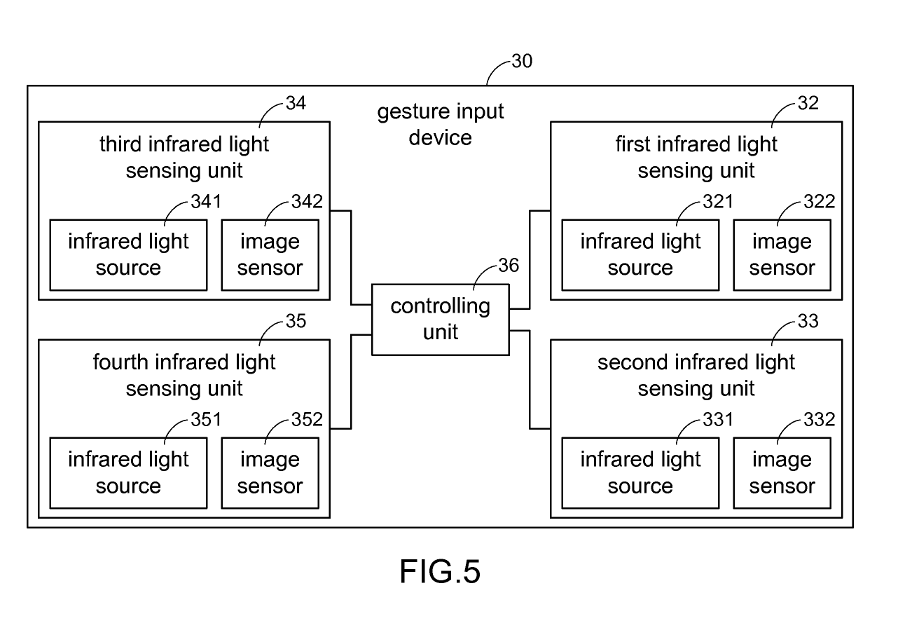

Please also refer to FIG. 5. FIG. 5 is a schematic functional block diagram illustrating the gesture input device according to the second embodiment of the present invention. As shown in FIGS. 4 and 5, the gesture input device 30 comprises an operating plate 31, a first infrared light sensing unit 32, a second infrared light sensing unit 33, a third infrared light sensing unit 34, a fourth infrared light sensing unit 35, and a controlling unit 36. For facilitating the user to grip the touch mouse more conveniently and comfortably, the operating plate 31 is an externally-convex curvy plate for placing the user's palm thereon.

The first infrared light sensing unit 32, the second infrared light sensing unit 33, the third infrared light sensing unit 34 and the fourth infrared light sensing unit 35 are disposed on a top surface of the operating plate 31 for detecting a movement of a user's finger over the operating plate 31. In this embodiment, the first infrared light sensing unit 32 and the second infrared light sensing unit 33 are arranged in a row. In addition, the first infrared light sensing unit 32 and the second infrared light sensing unit 33 are arranged side by side on the operating plate 31. The third infrared light sensing unit 34 and the fourth infrared light sensing unit 35 are arranged in a column. In addition, the third infrared light sensing unit 34 and the fourth infrared light sensing unit 35 are arranged up and down on the operating plate 31. As shown in FIG. 4, the first infrared light sensing unit 32, the second infrared light sensing unit 33 and the fourth infrared light sensing unit 35 are located near a rear end of the top surface of the operating plate 31, and the third infrared light sensing unit 34 is located near a front end of the top surface of the operating plate 31. Moreover, the first infrared light sensing unit 32, the fourth infrared light sensing unit 35 and the second infrared light sensing unit 33 are sequentially arranged from left to right.

The first infrared light sensing unit 32 comprises an infrared light source 321 and an image sensor 322. The second infrared light sensing unit 33 comprises an infrared light source 331 and an image sensor 332. The third infrared light sensing unit 34 comprises an infrared light source 341 and an image sensor 342. The fourth infrared light sensing unit 35 comprises an infrared light source 351 and an image sensor 352.

The controlling unit 36 is disposed within the operating plate 31, and electrically connected with the first infrared light sensing unit 32, the second infrared light sensing unit 33, the third infrared light sensing unit 34 and the fourth infrared light sensing unit 35. The signals from the first infrared light sensing unit 32, the second infrared light sensing unit 33, the third infrared light sensing unit 34 and the fourth infrared light sensing unit 35 may be received by the controlling unit 36. According to the signals from the first infrared light sensing unit 32, the second infrared light sensing unit 33, the third infrared light sensing unit 34 and the fourth infrared light sensing unit 35, the controlling unit 36 generates a corresponding gesture signal. According to the gesture signal, the computer 40 is correspondingly controlled.

The infrared light sources 321, 331, 341 and 351 may emit infrared light beams to the user's finger. The image sensors 322, 332, 342 and 352 may receive reflected infrared light beams from the user's finger and generate plural infrared images according to the reflected infrared light beams. According to the plural infrared images, a displacement information about the movement of the user's finger is acquired. The operating principles of the infrared light sensing units of the second embodiment are substantially identical to those of the infrared light sensing units of FIGS. 1-3, and are not redundantly described herein.

For example, the user's finger may be moved from the position over the first infrared light sensing unit 32 to the position over the second infrared light sensing unit 33 while the user's finger is contacted with the operating plate 31 or not contacted with the operating plate 31. Consequently, a gesture indicating the movement along an X-axis direction is generated. Under this circumstance, the image of the user's finger is firstly contained in the plural infrared images that are generated by the first infrared light sensing unit 32, and then contained in the plural infrared images that are generated by the second infrared light sensing unit 33.

After the plural infrared images from the first infrared light sensing unit 32 and the second infrared light sensing unit 33 are received by the controlling unit 36, the plural infrared images are analyzed by the controlling unit 36 according to the well-known image recognition method. Consequently, a displacement information indicating the movement of the user's finger from left to right is realized by the controlling unit 36. According to the displacement information, the controlling unit 36 generates a corresponding gesture signal to the computer 40 in order to control the computer 40.

Moreover, the user's finger may be moved from the position over the third infrared light sensing unit 34 to the position over the fourth infrared light sensing unit 35 while the user's finger is contacted with the operating plate 31 or not contacted with the operating plate 31. Consequently, a gesture indicating the movement along a Y-axis direction is generated. Under this circumstance, the image of the user's finger is firstly contained in the plural infrared images that are generated by the third infrared light sensing unit 34, and then contained in the plural infrared images that are generated by the fourth infrared light sensing unit 35.

After the plural infrared images from the third infrared light sensing unit 34 and the fourth infrared light sensing unit 35 are received by the controlling unit 36, the plural infrared images are analyzed by the controlling unit 36. Consequently, a displacement information indicating the movement of the user's finger from up to down is realized by the controlling unit 36. According to the displacement information, the controlling unit 36 generates a corresponding gesture signal to the computer 40 in order to control the computer 40.

Similarly, the user's finger may be moved from the position over the second infrared light sensing unit 33 to the position over the first infrared light sensing unit 32 while the user's finger is contacted with the operating plate 31 or not contacted with the operating plate 31. Consequently, a displacement information indicating the movement of the user's finger is moved from right to left is realized by the controlling unit 36. According to the displacement information, the controlling unit 36 generates a corresponding gesture signal to the computer 40. Similarly, the user's finger may be moved from the position over the fourth infrared light sensing unit 35 to the position over the third infrared light sensing unit 34 while the user's finger is contacted with the operating plate 31 or not contacted with the operating plate 31. Consequently, a displacement information indicating the movement of the user's finger from down to up is realized by the controlling unit 36. According to the displacement information, the controlling unit 36 generates a corresponding gesture signal to the computer 40.

The control function corresponding to the above-mentioned gesture signal may be defined by the controlling unit 36 of the gesture input device 30 or defined by a specified application program of the computer 40. The control function may be the well-known control functions of controlling the computer 40. An example of the control function includes but is not limited to a function of controlling cursor movement.

For example, if the displacement information indicates that the user's finger is moved from left to right, a cursor 42 shown on a display screen of the computer 40 is moved toward the right side of the X-axis direction according to the gesture signal. On the other hand, if the displacement information indicates that the user's finger is moved from right to left, the cursor 42 shown on the display screen of the computer 40 is moved toward the left side of the X-axis direction according to the gesture signal. Similarly, if the displacement information indicates that the user's finger is moved from up to down, the cursor 42 shown on the display screen of the computer 40 is moved toward the down side of the Y-axis direction according to the gesture signal. On the other hand, if the displacement information indicates that the user's finger is moved from down to up, the cursor 42 shown on the display screen of the computer 40 is moved toward the up side of the Y-axis direction according to the gesture signal.

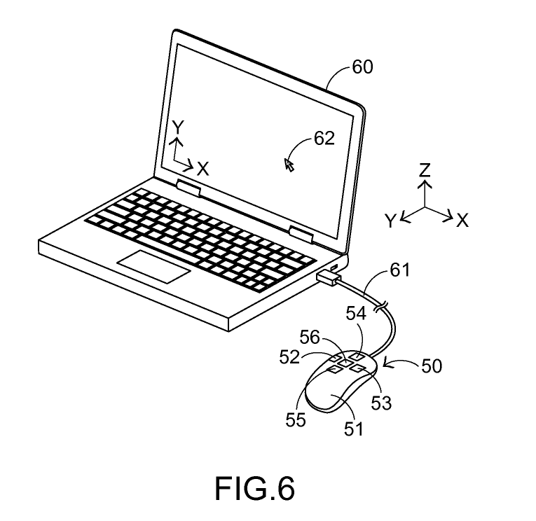

Hereinafter, a third embodiment of the present invention will be illustrated with reference to FIG. 6. FIG. 6 schematically illustrates the connection between a gesture input device and a computer according to a third embodiment of the present invention. As known in FIG. 6, the gesture input device 50 is in communication with the computer 60 through a USB connecting wire 61. Via the gesture input device 50, a gesture signal is inputted into the computer 60 in order to control the computer 60. In this embodiment, the gesture input device 50 is a touch mouse for controlling cursor movement of the computer 60. Except that the gesture input device 50 of the third embodiment further comprises a fifth infrared light sensing unit, the configurations and operating principles of the gesture input device 50 of the third embodiment are substantially identical to those of the gesture input device 30 of FIGS. 4-5.

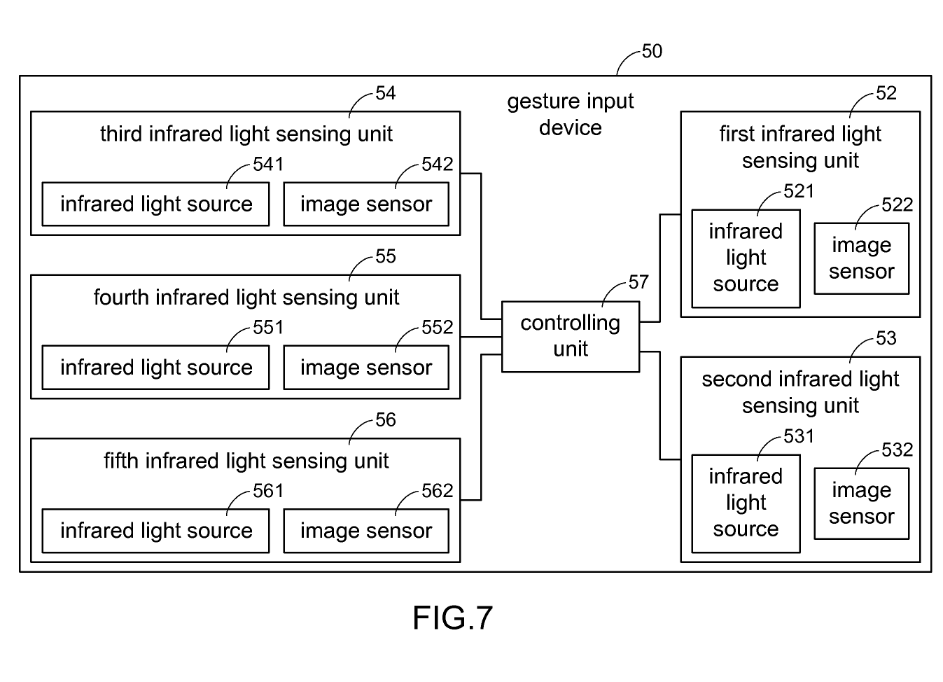

Please also refer to FIG. 7. FIG. 7 is a schematic functional block diagram illustrating the gesture input device according to the third embodiment of the present invention. As shown in FIGS. 6 and 7, the gesture input device 50 comprises an operating plate 51, a first infrared light sensing unit 52, a second infrared light sensing unit 53, a third infrared light sensing unit 54, a fourth infrared light sensing unit 55, a fifth infrared light sensing unit 56, and a controlling unit 57. For facilitating the user to grip the touch mouse more conveniently and comfortably, the operating plate 51 is an externally-convex curvy plate for placing the user's palm thereon.

The first infrared light sensing unit 52, the second infrared light sensing unit 53, the third infrared light sensing unit 54, the fourth infrared light sensing unit 55 and the fifth infrared light sensing unit 56 are disposed on a top surface of the operating plate 51. The first infrared light sensing unit 52, the second infrared light sensing unit 53, the third infrared light sensing unit 54 and the fourth infrared light sensing unit 55 are used for detecting a movement of a user's finger over the operating plate 51. The fifth infrared light sensing unit 56 is used for detecting a distance of the user's finger from the fifth infrared light sensing unit 56 along a direction perpendicular to the operating plate 51.

In this embodiment, the first infrared light sensing unit 52 and the second infrared light sensing unit 53 are arranged in a row. In addition, the first infrared light sensing unit 52 and the second infrared light sensing unit 53 are arranged side by side on the operating plate 51. The third infrared light sensing unit 54 and the fourth infrared light sensing unit 55 are arranged in a column. In addition, the third infrared light sensing unit 54 and the fourth infrared light sensing unit 55 are arranged up and down on the operating plate 51. As shown in FIG. 6, the third infrared light sensing unit 54 is located near a front end of the top surface of the operating plate 51, and the fourth infrared light sensing unit 55 is located near a rear end of the top surface of the operating plate 51. The first infrared light sensing unit 52, the second infrared light sensing unit 53 and the fifth infrared light sensing unit 56 are arranged between the third infrared light sensing unit 54 and the fourth infrared light sensing unit 55. Moreover, the first infrared light sensing unit 52, the fifth infrared light sensing unit 56 and the second infrared light sensing unit 53 are sequentially arranged from left to right.

As mentioned above, the fifth infrared light sensing unit 56 is enclosed by the first infrared light sensing unit 52, the second infrared light sensing unit 53, the third infrared light sensing unit 54 and the fourth infrared light sensing unit 55. However, it is noted that the position of the fifth infrared light sensing unit 56 is not restricted.

The first infrared light sensing unit 52 comprises an infrared light source 521 and an image sensor 522. The second infrared light sensing unit 53 comprises an infrared light source 531 and an image sensor 532. The third infrared light sensing unit 54 comprises an infrared light source 541 and an image sensor 542. The fourth infrared light sensing unit 55 comprises an infrared light source 551 and an image sensor 552. The fifth infrared light sensing unit 56 comprises an infrared light source 561 and an image sensor 562. The operating principles of the first, second, third, fourth and fifth infrared light sensing units of the third embodiment are substantially identical to those of the first, second, third and fourth infrared light sensing units of FIGS. 4-5. Consequently, the operating principles of using the infrared light sensing units to detect the user's finger are not redundantly described herein.

The controlling unit 57 is disposed within the operating plate 51, and electrically connected with the first infrared light sensing unit 52, the second infrared light sensing unit 53, the third infrared light sensing unit 54, the fourth infrared light sensing unit 55 and the fifth infrared light sensing unit 56. The signals from the first infrared light sensing unit 52, the second infrared light sensing unit 53, the third infrared light sensing unit 54, the fourth infrared light sensing unit 55 and the fifth infrared light sensing unit 56 may be received by the controlling unit 57. According to these signals, the controlling unit 57 generates a corresponding gesture signal. According to the gesture signal, the computer 60 is correspondingly controlled.

The control function corresponding to the above-mentioned gesture signal may be defined by the controlling unit 57 of the gesture input device 50 or defined by a specified application program of the computer 60. The control function may be the well-known control functions of controlling the computer 60. An example of the control function includes but is not limited to a function of controlling cursor movement.

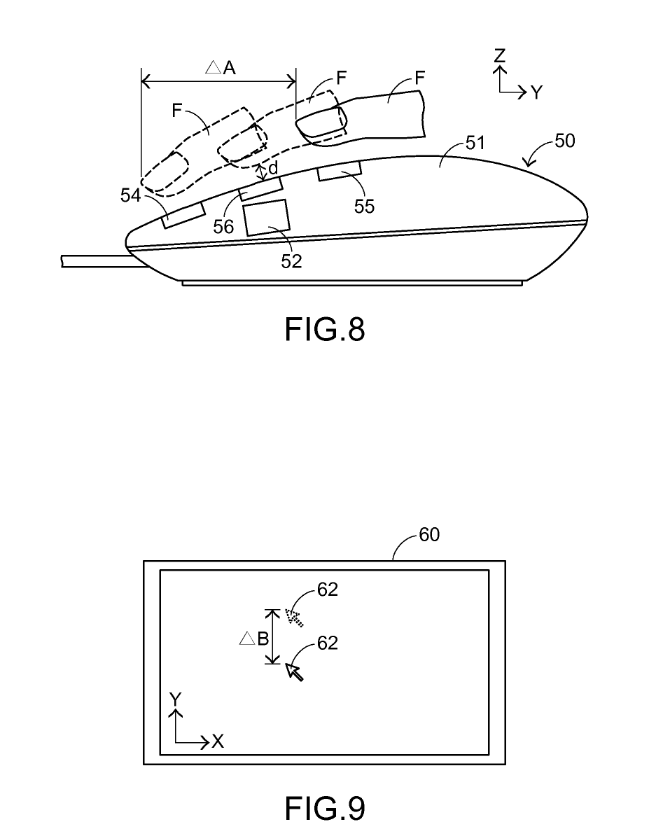

Please refer to FIGS. 8 and 9. FIG. 8 schematically illustrates the relation between the user's finger and the gesture input device according to the third embodiment of the present invention. FIG. 9 schematically illustrates the cursor movement controlled by the gesture input device according to the third embodiment of the present invention. For example, the user's finger F may be moved from the position over the third infrared light sensing unit 54 to the position over the fourth infrared light sensing unit 55 for a distance AA while the user's finger is contacted with the operating plate 51 or not contacted with the operating plate 51. Consequently, a gesture indicating the movement along a Y-axis direction is generated. While the user's finger F is moved from the position over the third infrared light sensing unit 54 to the position over the fourth infrared light sensing unit 55, the user's finger F is moved across the fifth infrared light sensing unit 56. Under this circumstance, the image of the user's finger F is firstly contained in the plural infrared images that are generated by the third infrared light sensing unit 54, then contained in the plural infrared images that are generated by the fifth infrared light sensing unit 56, and finally contained in the plural infrared images that are generated by the fourth infrared light sensing unit 55.

After the plural infrared images from the third infrared light sensing unit 54, the fourth infrared light sensing unit 55 and the fifth infrared light sensing unit 56 are received by the controlling unit 57, the plural infrared images from the third infrared light sensing unit 54 and the fourth infrared light sensing unit 55 are analyzed by the controlling unit 57 according to the well-known image recognition method. Consequently, a displacement information indicating the movement of the user's finger F from up to down is realized by the controlling unit 57. Moreover, after the plural infrared images from the fifth infrared light sensing unit 56 are analyzed by the controlling unit 57, the distance d between the user's finger F and the fifth infrared light sensing unit 56 is acquired by the controlling unit 57.

According to the acquired displacement information and the acquired distance d between the user's finger F and the fifth infrared light sensing unit 56, the controlling unit 57 determines a single moving distance corresponding to the displacement information, and generates the corresponding gesture signal to the computer 60. According to the gesture signal, the computer 60 is correspondingly controlled. For example, the user's finger F may be moved from the position over the third infrared light sensing unit 54 to the position over the fourth infrared light sensing unit 55 for the distance AA along the Y-axis direction (i.e. the displacement information indicates the movement of the user's finger F from up to down). While the user's finger F is moved to the position over the fifth infrared light sensing unit 56, a larger distance d between the user's finger F and the fifth infrared light sensing unit 56 denotes that a moving distance AB of the cursor 62 of the computer 60 toward the down side of the Y-axis direction is larger, and a smaller distance d between the user's finger F and the fifth infrared light sensing unit 56 denotes that a moving distance AB of the cursor 62 of the computer 60 toward the down side of the Y-axis direction is smaller.

On the other hand, as shown in FIG. 6, the user's finger F may be moved from the position over the first infrared light sensing unit 52 to the position over the second infrared light sensing unit 53. Consequently, a gesture indicating the movement along an X-axis direction is generated. While the user's finger F is moved from the position over the first infrared light sensing unit 52 to the position over the second infrared light sensing unit 53, the user's finger F is moved across the fifth infrared light sensing unit 56. Under this circumstance, the image of the user's finger F is firstly contained in the plural infrared images that are generated by the first infrared light sensing unit 52, then contained in the plural infrared images that are generated by the fifth infrared light sensing unit 56, and finally contained in the plural infrared images that are generated by the second infrared light sensing unit 53.

After the plural infrared images from the first infrared light sensing unit 52, the second infrared light sensing unit 53 and the fifth infrared light sensing unit 56 are received by the controlling unit 57, the plural infrared images from the first infrared light sensing unit 52 and the second infrared light sensing unit 53 are analyzed by the controlling unit 57 according to the well-known image recognition method. Consequently, a displacement information indicating the movement of the user's finger F from left to right is realized by the controlling unit 57. Moreover, after the plural infrared images from the fifth infrared light sensing unit 56 are analyzed by the controlling unit 57, the distance d between the user's finger F and the fifth infrared light sensing unit 56 is acquired by the controlling unit 57 (see FIG. 8).

According to the acquired displacement information and the acquired distance d between the user's finger F and the fifth infrared light sensing unit 56, the controlling unit 57 determines a single moving distance corresponding to the displacement information, and generates the corresponding gesture signal to the computer 60. According to the gesture signal, the moving distance of the cursor 62 of the computer 60 along the X-axis direction is correspondingly controlled. The method of controlling the movement of the cursor 62 along the X-axis direction is similar to the method of controlling the movement of the cursor 62 along the Y-axis direction, and is not redundantly described herein.

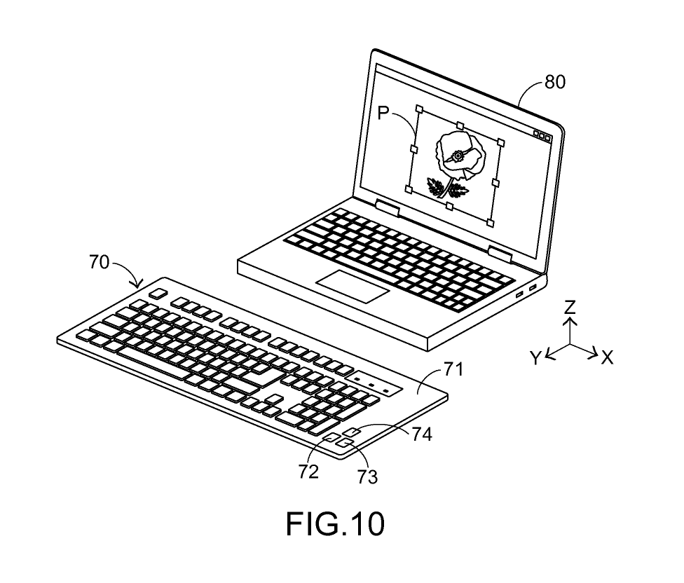

Hereinafter, a fourth embodiment of the present invention will be illustrated with reference to FIG. 10. FIG. 10 schematically illustrates the connection between a gesture input device and a computer according to a fourth embodiment of the present invention. As known in FIG. 10, the gesture input device 70 is in communication with the computer 80 through a Bluetooth wireless communication module (not shown). Via the gesture input device 70, a gesture signal is inputted into the computer 80 in order to control the computer 80. In this embodiment, the gesture input device 70 is a touch keyboard. The gesture input device 70 is used for controlling an image P shown on a display screen of the computer 80, but is not limited thereto. Except for the number of the infrared light sensing units and the control function of the gesture control, the configurations and operating principles of the gesture input device 70 of the fourth embodiment are substantially identical to those of the gesture input device 10 of FIGS. 1-3.

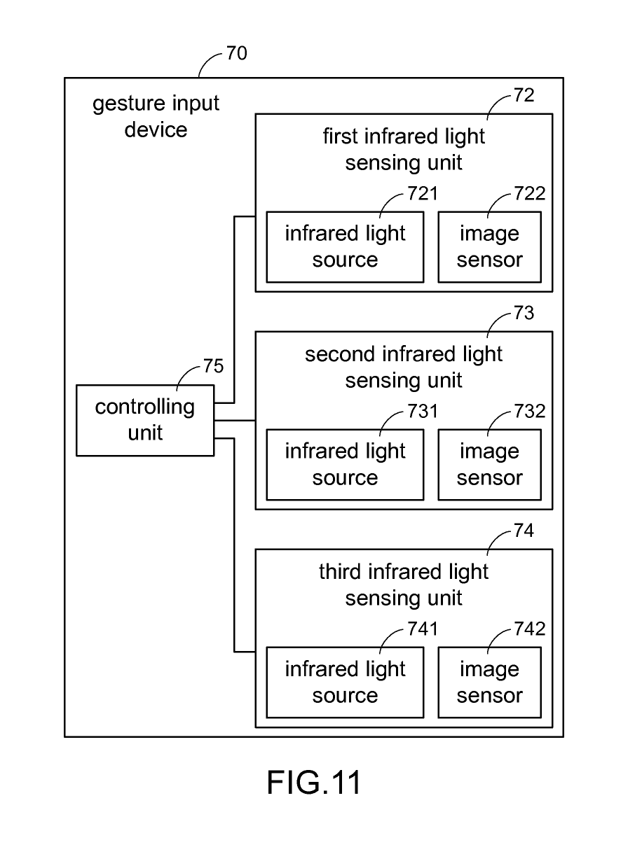

Please also refer to FIG. 11. FIG. 11 is a schematic functional block diagram illustrating the gesture input device according to the fourth embodiment of the present invention. As shown in FIGS. 10 and 11, the gesture input device 70 comprises an operating plate 71, a first infrared light sensing unit 72, a second infrared light sensing unit 73, a third infrared light sensing unit 74, and a controlling unit 75. In this embodiment, the operating plate 71 is an upper cover of a touch keyboard for placing the user's palm thereon.

The first infrared light sensing unit 72, the second infrared light sensing unit 73 and the third infrared light sensing unit 74 are disposed on a top surface of the operating plate 71 for detecting a movement of a user's finger over the operating plate 71. In this embodiment, the first infrared light sensing unit 72 and the second infrared light sensing unit 73 are arranged in a row. In addition, the first infrared light sensing unit 72 and the second infrared light sensing unit 73 are arranged side by side on the operating plate 71. As shown in FIG. 10, the first infrared light sensing unit 72 is located at a left side of the light sensing unit 73, and the third infrared light sensing unit 74 is located at up sides of the first infrared light sensing unit 72 and the second infrared light sensing unit 73.

The first infrared light sensing unit 72 comprises an infrared light source 721 and an image sensor 722. The second infrared light sensing unit 73 comprises an infrared light source 731 and an image sensor 732. The third infrared light sensing unit 74 comprises an infrared light source 741 and an image sensor 742.

The infrared light sources 721, 731 and 741 may emit infrared light beams to the user's finger. The image sensors 722, 732 and 742 may receive reflected infrared light beams from the user's finger and generate plural infrared images according to the reflected infrared light beams. According to the plural infrared images, a displacement information about the movement of the user's finger is acquired. The operating principles of the infrared light sensing units of the fourth embodiment are substantially identical to those of the infrared light sensing units of FIGS. 1-3, and are not redundantly described herein.

The controlling unit 75 is disposed within the operating plate 71, and electrically connected with the first infrared light sensing unit 72, the second infrared light sensing unit 73 and the third infrared light sensing unit 74. The signals from the first infrared light sensing unit 72, the second infrared light sensing unit 73 and the third infrared light sensing unit 74 may be received by the controlling unit 75. According to these signals, the controlling unit 75 generates a corresponding gesture signal. According to the gesture signal, the computer 80 is correspondingly controlled.

For example, the user's finger may be moved from the position over the first infrared light sensing unit 72 to the position over the second infrared light sensing unit 73 while the user's finger is contacted with the operating plate 71 or not contacted with the operating plate 71. Consequently, a gesture indicating the movement along an X-axis direction is generated. Under this circumstance, the image of the user's finger is firstly contained in the plural infrared images that are generated by the first infrared light sensing unit 72, and then contained in the plural infrared images that are generated by the second infrared light sensing unit 73.

After the plural infrared images from the first infrared light sensing unit 72 and the second infrared light sensing unit 73 are received by the controlling unit 75, the plural infrared images are analyzed by the controlling unit 75. Consequently, a displacement information indicating the movement of the user's finger from left to right is realized by the controlling unit 75. According to the displacement information, the controlling unit 75 generates a corresponding gesture signal to the computer 80 in order to control the computer 80.

The control function corresponding to the above-mentioned gesture signals may be defined by the controlling unit 75 of the gesture input device 70 or defined by a specified application program of the computer 80. The control function may be the well-known control functions of controlling the computer 80. An example of the control function includes but is not limited to a function of controlling sound volume, a function of controlling the direction of flipping pages, a function of controlling the direction of scrolling a window or a function of controlling the direction of the cursor.

For example, a user's finger (e.g. a forefinger of the right hand) may be moved from the position over the first infrared light sensing unit 72 to the position over the second infrared light sensing unit 73 while another user's finger (e.g. a forefinger of the left hand) is statically stayed over the third infrared light sensing unit 74. Under this circumstance, plural infrared images of the forefinger of the left hand are continuously generated by the third infrared light sensing unit 74. In addition, the image of the forefinger of the right hand is firstly contained in the plural infrared images that are generated by the first infrared light sensing unit 72, and then contained in the plural infrared images that are generated by the second infrared light sensing unit 73.

After the plural infrared images from the first infrared light sensing unit 72, the second infrared light sensing unit 73 and the third infrared light sensing unit 74 are received by the controlling unit 75, the plural infrared images from the first infrared light sensing unit 72 and the second infrared light sensing unit 73 are analyzed by the controlling unit 75 according to the well-known image recognition method. Consequently, a displacement information indicating the movement of the forefinger of the right hand from left to right is realized by the controlling unit 75. Moreover, after the plural infrared images from the third infrared light sensing unit 74 are analyzed by the controlling unit 75, a position information associated with the position of the forefinger of the left hand is acquired. According to the position information, the controlling unit 75 judges whether the forefinger of the left hand is continuously stayed over the third infrared light sensing unit 74. If the controlling unit 75 judges that the forefinger of the left hand is continuously stayed over the third infrared light sensing unit 74, the position information associated with the position of the forefinger of the left hand is acquired by the controlling unit 75. According to the displacement information associated with the forefinger of the right hand and the position information associated with the forefinger of the left hand, the controlling unit 75 generates a corresponding gesture signal in order to control the computer 80.

For example, when the finger of the user's right hand is moved from the position over the first infrared light sensing unit 72 to the position over the second infrared light sensing unit 73 and the finger of the user's left hand is continuously and statically stayed over the third infrared light sensing unit 74, the controlling unit 75 generates a corresponding gesture signal. According to the gesture signal, the image P shown on the display screen of the computer 80 is enlarged. On the other hand, when the finger of the user's right hand is moved from the position over the second infrared light sensing unit 73 to the position over the first infrared light sensing unit 72 and the finger of the user's left hand is continuously and statically stayed over the third infrared light sensing unit 74, the controlling unit 75 generates a corresponding gesture signal. According to the gesture signal, the image P shown on the display screen of the computer 80 is shrunk.

In this embodiment, the image P is proportionally enlarged or shrunk, but is not limited thereto. Moreover, other control functions of the computer 80 may be controlled according to the gesture signal generated by the controlling unit 75. For example, the control function may include a function of controlling the rotating direction of the image P, a function of controlling a playing progress of a multimedia file of the computer 80 or a function of controlling playback of song repertoire of the computer 80.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A gesture input device for inputting a gesture signal into a computer, the gesture input device comprising:
an operating plate;
a first infrared light sensing unit and a second infrared light sensing unit disposed on the operating plate, and detecting a movement of a finger of a user, wherein the first infrared light sensing unit and the second infrared light sensing unit are arranged in a row, wherein each of the first infrared light sensing unit and the second infrared light sensing unit comprises:
an infrared light source emitting an infrared light beam that is absorbable by plural blood vessels of the finger, wherein when the infrared light beam from the infrared light source is projected on the finger, a first portion of the infrared light beam within a specified wavelength range is absorbed by the plural blood vessels of the finger, and a second portion of the infrared light beam beyond the specified wavelength range is reflected from the plural blood vessels; and
an image sensor, wherein after the second portion of the infrared light beam reflected from the finger is received by the image sensor, plural infrared images are generated; and
a controlling unit electrically connected with the first infrared light sensing unit and the second infrared light sensing unit, wherein when the finger is moved from a position over the first infrared light sensing unit to a position over the second infrared light sensing unit, the plural infrared images are generated by the first infrared light sensing unit and the second infrared light sensing unit, wherein according to the plural infrared images, the controlling unit generates a displacement information corresponding to the movement of the finger in order to control the computer.

2. The gesture input device according to claim 1, wherein the movement of the finger is a gesture indicating a movement along an X-axis direction, so that a sound volume, a direction of flipping a page or a direction of scrolling a window is correspondingly controlled.

3. The gesture input device according to claim 1, further comprising a third infrared light sensing unit and a fourth infrared light sensing unit, wherein the third infrared light sensing unit and the fourth infrared light sensing unit are disposed on the operating plate and detects a second movement of the finger, wherein the third infrared light sensing unit and the fourth infrared light sensing unit are arranged in a column, wherein when the finger is moved from a position over the third infrared light sensing unit to a position over the fourth infrared light sensing unit, the plural infrared images are generated by the third infrared light sensing unit and the fourth infrared light sensing unit, wherein according to the plural infrared images, the controlling unit generates a second displacement information corresponding to the second movement of the finger in order to control the computer.

4. The gesture input device according to claim 3, wherein the second movement of the finger is a gesture indicating a movement along a Y-axis direction.

5. The gesture input device according to claim 3, wherein a cursor of the computer to be moved along the X-axis direction is controlled according to detecting results of the first infrared light sensing unit and the second infrared light sensing unit, wherein the cursor of the computer to be moved along the Y-axis direction is controlled according to detecting results of the third infrared light sensing unit and the fourth infrared light sensing unit.

6. The gesture input device according to claim 3, further comprising a fifth infrared light sensing unit, wherein the fifth infrared light sensing unit is disposed on the operating plate and detects a distance of the finger from the fifth infrared light sensing unit along a direction perpendicular to the operating plate, wherein according to the distance, the controlling unit determines a single moving distance corresponding to the displacement information and a single moving distance corresponding to the second displacement information.

7. The gesture input device according to claim 1, further comprising a third infrared light sensing unit, wherein when the finger is moved from the position over the first infrared light sensing unit to the position over the second infrared light sensing unit and a second finger of the user is statically stayed over the third infrared light sensing unit, the plural infrared images are generated by the first infrared light sensing unit, the second infrared light sensing unit and the third infrared light sensing unit, wherein the displacement information of the finger and a position information of the second finger are acquired by the controlling unit according to the plural infrared images, and the computer is controlled by the controlling unit according to the displacement information and the position information.

8. The gesture input device according to claim 7, wherein an image of the computer is controlled to be enlarged or shrunk according to the displacement information and the position information.

9. The gesture input device according to claim 1, wherein the gesture input device is applicable to a touch mouse, a touch keyboard, a touchpad or a touch screen.
